(19) United States
(12) Patent Application Publication
(10) Pub. No.: US 2026/0296083 A1
(43) Pub. Date: Oct. 1, 2026

(54) LASER MARKING OF CONTAINERS

(71) Applicant: KRONES AG, Neutraubling (DE)

(72) Inventors: Andreas KRAUS, Lappersdorf (DE); Helmut SCHNEIDER, Regensburg (DE); Peter LINDNER, Langquaid (DE); Bernd BRAATZ, Alteglofsheim (DE); Florian LAUTERBACH, Illkofen (DE); Josef MAYER, Regensburg (DE); Juergen FRANKERL, Nittenau (DE)

(21) Appl. No.: 19/490,845

(22) PCT Filed: Jun. 3, 2024
(86) PCT No.: PCT/EP2024/065227

§ 371 Date: Dec. 5, 2025

(30) Foreign Application Priority Data
Jun. 5, 2023 (DE) 10 2023 114 694.7

(51) Int. Cl. B41M 5/28; B41J 2/44; B41J 3/407; G02B 5/124

(52) U.S. Cl. CPC B41M 5/282; B41J 2/442; B41J 3/40733; G02B 5/124

(57) ABSTRACT

The invention relates to, inter alia, a method for marking containers (12). The method involves laser marking a laser marking (36) on a container (12) by means of a laser marking system (10) in such a way that a surface of the laser marking (36) has at least one predetermined structuring (38), generated by the laser marking system (10), preferably in order to create an optical effect via the at least one predetermined structuring (38). (FIG. 2)

### TECHNICAL FIELD

The invention relates to a method for marking containers. The invention further relates to a container. The invention additionally relates to an apparatus for marking containers.

### TECHNICAL BACKGROUND

Traditionally, containers, such as beverage containers, are marked using conventional labeling methods. This serves, firstly, for identification and differentiation from competitors, and secondly, to label ingredients and specify legal requirements. Additional information, such as the expiration date, can be applied using a laser unit, for example. For container decorations that do not use labels, combinations of different technologies (e.g., embossing, printing, laser marking) can be used.

A disadvantage of the known prior art can, for example, be that the processes are comparatively complex, e.g., direct printing, and thus sometimes produce high costs. The decoration cannot be easily customized using conventional methods, which is problematic for small batches and fully-customized containers (batch size 1). Furthermore, conventional decoration may exhibit less than ideal legibility of the elements and less than ideal contrast. Furthermore, there may be little flexibility regarding the visual impression-for example, in the case of laser marking. Overall, this means there are few or no opportunities for differentiation or demarcation from the competition.

The invention addresses the problem of creating an improved technique for marking containers, preferably enabling particularly good legibility and particularly good contrast of the marking.

### SUMMARY OF THE INVENTION

The object is achieved by the features of the independent claims. Advantageous developments are specified in the dependent claims and the description.

One aspect of the present disclosure relates to a method for marking containers (e.g., for use in a container processing facility). The method involves laser marking of a laser marking on a container (or its container surface) by a laser marking system (e.g., laser pulse marking system) in such a way that a surface of the laser marking has at least one predetermined (e.g., micro-and/or nano-) structuring generated by the laser marking system, preferably in order to create an optical (e.g., reflection) effect via the at least one predetermined structuring.

Advantageously, the laser marking system can thus laser mark a desired laser marking (laser-marked decoration), e.g., with graphics, logo, and/or lettering, and additionally generate targeted optical effects of the laser marking or decoration via the predetermined structuring(s) of the surface. This allows for the advantageous adjustment and improvement of legibility and contrast (sharpness) in desired regions (=where the predetermined structuring(s) is/are). Further potential for improving legibility and contrast lies in the targeted combination of different structurings, which can, for example, be adjacent to each other. Overall, this can advantageously allow for greater freedom in the individual configuration of the decoration and thus, for example, improved opportunities for differentiation from the competition.

In one exemplary embodiment, the at least one predetermined structuring has several predetermined structurings that differ structurally from one another (e.g., are differently recessed or raised), preferably in order to create different optical effects (e.g., reflections) via the several predetermined structurings. This allows the potential for improving legibility and contrast to be used advantageously through the targeted combination of different structurings, wherein the different structurings create, for example, combinations of different reflections of incident light (e.g., combination of retroreflection, diffuse reflection, and/or regular reflection).

In another exemplary embodiment, the several predetermined structurings are directly adjacent to each other, or a first of the several predetermined structurings surrounds a second of the several predetermined structurings (e.g., partially or completely), preferably adjacently to the second predetermined structuring. This can significantly improve legibility and contrast, since the optically induced effect changes abruptly at a boundary between the predetermined structurings.

In one embodiment, the at least one predetermined structuring has several structures, which are preferably at least one of the following:
arranged regularly or irregularly;
arranged side-by-side in a grid, pattern, or line;
adjacent to each other;
structurally the same or structurally different; and
microscale or nanoscale.

This allows for the advantageous achievement of a wide variety of optical effects, which are aimed in particular at different reflection behavior of incident light.

In another embodiment, the several structures have several (e.g., microscale or nanoscale) honeycomb structures, several (e.g., microscale or nanoscale) angle reflector structures, several (e.g., microscale or nanoscale) lens reflector structures, several (e.g., microscale or nanoscale) irregular structures, several caterpillar-like structures, several interlocking or meandering structures, and/or at least one planar surface structure that is substantially planar at the microscale or nanoscale. This allows for the targeted creation of portions with predominantly retroreflection, diffuse reflection, and/or regular reflection.

In one embodiment variant, the several structures are each at least partially raised, preferably foamed, and/or at least partially recessed, preferably abraded. This makes it advantageous to create targeted combinations of structures that can achieve very specific optical effects to improve legibility and contrast.

In another embodiment variant, the at least one predetermined structuring has a retroreflector structuring configured to cause retroreflection of incident light. This allows retroreflection to be achieved as a desired optical effect, which can be used in laser marking to specifically increase legibility and contrast, especially in combination with an adjacent regular reflector structuring and/or a diffuse reflector structuring.

In one exemplary embodiment, the retroreflector structuring has at least one of:
several (e.g., abraded) (e.g., microscale or nanoscale) honeycomb structures;
several (e.g., abraded) (e.g., microscale or nanoscale) angle reflector structures, preferably each with three reflector surfaces arranged at an angle to each other, which are arranged as triple mirrors; and
several (e.g., foamed) (e.g., microscale or nanoscale) lens reflector structures, preferably in circular, rod, or (e.g., curved or intertwined or meandering or wavy) caterpillar shape.

Advantageously, the honeycomb structures, angle reflector structures, and/or incident light can substantially reflect as retroreflectors, thus achieving a desired optical effect in this region of the laser marking.

In another exemplary embodiment, the at least one predetermined structuring has a regular reflector structuring configured to cause regular reflection of incident light. This allows regular reflection to be achieved as a desired optical effect, which can be used in laser marking to specifically increase legibility and contrast, especially in combination with an adjacent retroreflector structuring and/or a diffuse reflector structuring.

In one embodiment, the regular reflector structuring has at least one planar surface structure that is substantially planar at the microscale or nanoscale. Advantageously, the planar surface structure can reflect incident light substantially regularly or directly, thus achieving a desired optical effect in this region of the laser marking.

In another embodiment, the at least one predetermined structuring has a diffuse reflector structuring configured to cause diffuse reflection of incident light. Optionally, the diffuse reflector structuring can have several (e.g., microscale or nanoscale) irregular structures that are distributed, preferably resulting in an irregularly roughened microscale or nanoscale surface. This allows diffuse reflection to be achieved as a desired optical effect, which can be used in laser marking to specifically increase legibility and contrast, especially in combination with an adjacent retroreflector structuring and/or a regular reflector structuring.

Preferably, the retroreflector structuring, the regular reflector structuring, and/or the diffuse reflector structuring are directly adjacent to each other. This can advantageously enable particularly good legibility or particularly good contrast.

In one embodiment variant, the at least one structuring during laser marking is created by at least one of:
a laser beam angle of incidence, specifically prescribed for the respective predetermined structuring, on the container, or a combination of different laser beam angles of incidence, specifically prescribed for the respective predetermined structuring, on the container;
a laser beam intensity specifically prescribed for the respective predetermined structuring, or a combination of different laser beam intensities specifically prescribed for the respective predetermined structuring;
a laser beam wavelength specifically prescribed for the respective predetermined structuring, or a combination of different laser beam wavelengths specifically prescribed for the respective predetermined structuring;
a laser beam pulse duration specifically prescribed for the respective predetermined structuring, or a combination of different laser beam pulse durations specifically prescribed for the respective predetermined structuring (particularly preferred: combination of nanosecond pulses and picosecond pulses or combination of picosecond pulses and femtosecond pulses);
a spatial laser beam pulse spacing specifically prescribed for the respective predetermined structuring, or a combination of different spatial laser beam pulse spacings specifically prescribed for the respective predetermined structuring;
a temporal laser beam pulse interval specifically prescribed for the respective predetermined structuring, or a combination of different temporal laser beam pulse intervals specifically prescribed for the respective predetermined structuring; and
a focus diameter specifically prescribed for the respective predetermined structuring, or a combination of different focus diameters specifically prescribed for the respective predetermined structuring.

Advantageously, this allows a separate set of parameters to be specified for the laser marking system for each predetermined structuring, enabling the predetermined structuring to be generated reliably and repeatably. In particular, functional optical surfaces can be manufactured efficiently and with high accuracy using a combination of nano-, pico-, and/or femtosecond pulses and/or by specifically adjusting the laser beam angle of incidence.

In a further embodiment variant, the method further involves producing or treating, preferably coating, the container prior to laser marking in such a way that, at least in the region where the laser marking and/or the at least one predetermined structuring is laser marked, irreversibly thermochromic pigments or laser additives are introduced which react with a color change and/or a shading effect during laser marking. Advantageously, the desired optical effect, which is caused by the predetermined structuring, can be further enhanced, refined, or differentiated by the color change or shading effect-for example, in or next to the predetermined structuring.

In one exemplary embodiment, the method further involves (e.g., camera-supported) detection of the laser marking and/or the at least one predetermined structuring after laser marking by an inspection device, preferably camera-supported, and adjustment of the operation of the laser marking system and/or a container conveyor depending upon the detected laser marking and/or the detected at least one predetermined structuring by a controller. Advantageously, in this way the applied laser markings can be monitored. It is also possible to adjust (e.g., control in a closed-loop or open-loop manner) certain operating parameters of the apparatus—for example, of the container conveyor or the laser marking system.

Another aspect of the present disclosure relates to an (e.g., beverage) container, preferably a bottle or can, wherein the container has a laser marking which is produced or laser marked by a method as disclosed herein. Of course, the container can achieve the same advantages as already described with reference to the method.

A further aspect of the present disclosure relates to an apparatus for marking containers for a container processing facility. The apparatus includes a container conveyor for transporting the containers, preferably in an upright position, and a laser marking system for laser marking the containers transported by the container conveyor. The apparatus further has a controller configured to operate the apparatus to carry out a method as disclosed herein. Advantageously, the apparatus can achieve the same advantages as already explained with reference to the method.

Preferably, the apparatus can be included in a container processing facility for producing, cleaning, coating, checking, filling, closing, marking, and/or packaging containers for pasty or liquid media, preferably beverages or liquid foods.

For example, the containers can be configured as bottles, cans, tubes, canisters, cartons, vials, etc.

Preferably, the term “controller” can refer to an electronic system (e.g., embodied as a driver circuit or with microprocessors and memory) that can perform control tasks and/or regulating tasks and/or processing tasks depending upon the configuration. Although the term “control” is used herein, this can also comprise or be understood as “closed-loop control” or “control with feedback” and/or “processing” as appropriate.

The preferred embodiments and features of the invention described above can be combined with one another as desired.

### BRIEF DESCRIPTION OF THE FIGURES

Further details and advantages of the invention are described below with reference to the accompanying drawings. In the figures:

FIG. 1 shows a schematic representation of an exemplary apparatus for marking containers;

FIGS. 2-4 are schematic side views of containers with exemplary laser markings;

FIG. 5 shows a schematic plan view of a portion of a predetermined structuring;

FIG. 6 shows a sectional view of the predetermined structuring of FIG. 5;

FIG. 7 shows a schematic plan view of a portion of a predetermined structuring;

FIG. 8 shows a schematic sectional view of the predetermined structuring of FIG. 7;

FIG. 9 shows a schematic plan view of a portion of a predetermined structuring;

FIG. 10 shows a schematic sectional view of the predetermined structuring of FIG. 9;

FIG. 11 shows a schematic plan view of a portion of a predetermined structuring;

FIG. 12 shows a schematic sectional view of the predetermined structuring of FIG. 11;

FIG. 13 shows a schematic plan view of a portion of a predetermined structuring;

FIG. 14 shows a schematic sectional view of the predetermined structuring of FIG. 13;

FIG. 15 shows a schematic plan view of a portion of a predetermined structuring; and

FIG. 16 shows a schematic sectional view of the predetermined structuring of FIG. 15.

The embodiments shown in the drawings correspond at least in part, so that similar or identical parts are provided with the same reference signs, and reference is also made to the description of other embodiments or figures for the explanation thereof to avoid repetition.

### DETAILED DESCRIPTION OF EXEMPLARY EMBODIMENTS

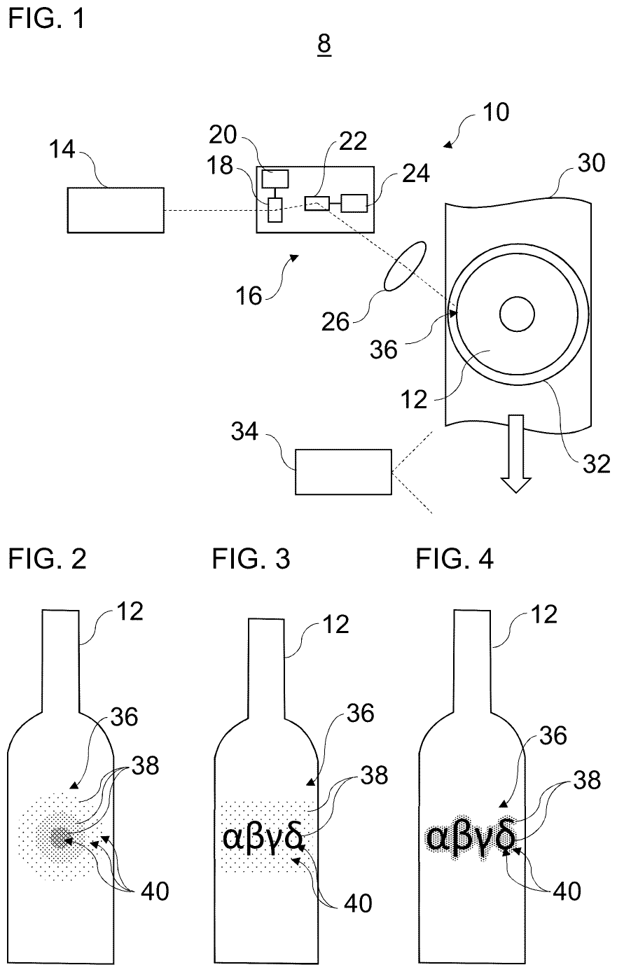

FIG. 1 shows an apparatus 8 for marking containers 12.

The apparatus 8 has a laser marking system 10. Preferably, the apparatus 8 can further have a container conveyor 30. Optionally, the apparatus 8 can for example also comprise an inspection device 34.

The laser marking system 10 can laser mark containers 12 or apply a laser marking 36 to the containers 12. The laser marking system 10 can also be referred to as a laser identification system, laser-coding system, or laser-inscription system. Preferably, the laser marking system 10 can be a CO₂ laser marking system, a fiber laser marking system, or a UV laser marking system. For example, the laser-marking system 10 may be a laser pulse marking system.

Preferably, the laser marking system 10 can have a laser source 14 and a marking head 16.

The laser source 14 can be embodied as a laser tube, for example. The laser tube may be sealed. The laser tube can be filled with a gas, e.g., containing CO₂, or a gas mixture, e.g., a CO₂—N₂—He gas mixture. Electrodes can also be arranged in the laser tube. A supply unit can be connected to the electrodes (not shown in FIG. 1). The supply unit can supply the laser source 14 with electrical energy. By a, for example, high-frequency voltage, molecules, e.g., CO₂ molecules, can be excited to oscillate in the laser tube and thus to emit a laser beam. The laser source 14 can also be referred to as an oscillator.

The laser beam generated by the laser source 14 can be guided or directed to the marking head 16 directly or via mirrors. It is possible for a so-called telescope for expanding the laser beam to be arranged between the laser source 14 and the marking head 16, for example.

The marking head 16 can preferably have two movable mirrors 18 and 22 and two drives 20 and 24. The marking head 16 can also have a focusing device 26. The marking head 16 can also be referred to as a coding head or writing head.

The first drive 20 can rotate the first mirror 18 about a first axis (e.g., X-axis). The first mirror 18 can, for example, also be referred to as a movable scanner mirror, e.g., an X-scanner mirror. The second drive 24 can rotate the second mirror 22 about a second axis (e.g., y-axis). The second mirror 22 can, for example, also be referred to as a movable scanner mirror, e.g., a Y-scanner mirror. The first axis and the second axis can preferably run perpendicular to each other.

The mirrors 18, 22 moved by the drives 20, 24 can direct the laser beam according to the desired laser marking 36. This allows the laser beam to move across the surface of the container 12 while writing, for example. Preferably, the laser beam can move across the surface of the container 12 within a marking field that is assigned to the respective marking head 16.

Before the laser beam impinges on the surface of the container 12, it can be focused by a focusing device 26. The focusing device 26 can, for example, have a focusing lens for this purpose. The focusing lens can also be referred to as a condenser lens. The focusing lens can be an F-theta lens, for example. Depending upon the configuration, the focusing lens can be arranged inside or outside the marking head 16. The focusing device 26 can also have a protective disk to protect the focusing lens, for example.

It is possible for the laser marking system 10 to have several marking heads 16. The several marking heads 16 can, for example, be arranged laterally side-by-side and/or one above the other. For example, two, three, or more marking heads 16 can be included.

Each marking head 16 can be connected to its own laser source 14, which can emit a laser beam to the respective marking head 16. Accordingly, the laser marking system 10 can have several laser sources 14.

It is also possible for several marking heads 16 to each receive their laser beams from the same laser source 14. For example, a beam splitter can be arranged between the laser source 14 and several marking heads 16. The beam splitter can, for example, split a laser beam received from the laser source 14 into several laser beams and guide these to the several marking heads 16.

For example, the marking heads 16 can generate or enable different laser beam angles of incidence on the container 12 and/or different spatial laser beam pulse spacings on the container 12. It is also possible that a single marking head 16 can generate or enable different laser beam angles of incidence on the container 12 and/or different spatial laser beam pulse intervals on the container 12.

If several laser sources 14 are included, these can, for example, be of identical form. However, it is also possible for the laser sources 14 to be at least partially formed differently in order to be able to produce different effects (e.g., color effects, haptic effects, surface structures) when laser marking the containers 12.

For example, the laser sources 14 can generate laser beams with different laser beam intensities, different laser beam wavelengths, and/or laser beam pulse durations. It is also possible that a single laser source 14 be configured to generate laser beams with different laser beam intensities, different laser beam wavelengths, and/or laser beam pulse durations.

The container conveyor 30 can transport the containers 12 in a transport direction (see arrow in FIG. 1).

For example, the container conveyor 30 can be a rotary container conveyor (container conveyor carousel). Alternatively, the container conveyor 30 can, for example, be a linear container conveyor.

The container conveyor 30 can support the containers 12 during transport, preferably on their base side, circumferential side, and/or mouth side. The container conveyor 30 can have container holders 32 for supporting the containers 12. The container holders 32 can preferably hold the containers 12 in base handling or neck handling.

It is possible that the container conveyor 30 have no separate container holders 32, and, for example, the containers 12 be simply supported on a, preferably circulating, conveying element (e.g., band, strap, belt, chains, or plates) of the container conveyor 30.

For example, the container holders 32 can each support a container 12. The container holders 32 can, for example, each have a container plate (e.g., container turntable), a centering bell, a container clamp, and/or an inflation apparatus. For example, one container 12 can be fixed between a container plate and a centering bell in each case. An optional, additional inflation apparatus can provide additional stability, e.g., if the containers 12 are marked before filling.

Preferably, the container conveyor 30 can be configured to rotate each of the transported containers 12 about its own vertical axis. Preferably, the container holders 32 can be rotatable for rotating the containers 12 about their respective vertical axis.

Preferably, the container conveyor 30 moves the containers 12 past the laser marking system 10 in the transport direction during the laser marking. Optionally, the containers 12 can be rotated about their own vertical axis by the container conveyor 30 during the laser marking. Alternatively, the containers 12 can, for example, remain stationary during laser marking.

Optionally, the apparatus 8 can further have the—preferably camera-supported—inspection device 34. The inspection device 60 can detect the laser markings 36 and/or predetermined structuring(s) 38 applied to the containers 12 by the laser marking system 10 and check or evaluate them—for example, with regard to quality, size, etc. Depending upon the evaluation, the operation of the apparatus 8 can be adapted, e.g., by a controller. For example, a container transport speed of the container conveyor 30 or a container rotational speed of the container conveyor 30 can be reduced if it is detected that the applied laser markings 36 and/or predetermined structurings 38 are incomplete, or a warning can be issued to a user via an output device.

The laser marking 36 applied by the laser marking system 10 can, for example, have a decoration (e.g., a decorative surface), at least one character, and/or a string of characters, preferably single-line or multi-line.

It is possible that, during laser marking using the laser marking system 10, irreversible thermochromic pigments or laser additives in or on the container 12 may react with a color change and/or a shading effect. For example, pigments or laser additives can be incorporated into the container material during the production of the containers 12. Alternatively, the container 12 can be coated externally with a coating containing the irreversible thermochromic pigments or laser additives prior to laser marking.

Specifically, chromophoric, irreversible thermochromic pigments, laser additives, or similar substances can be applied to the container 12 or introduced into the container wall. This preparation can be carried out during container production or separately, e.g., by coating, spraying, dipping, etc. It is also conceivable to incorporate it directly into the container base material. In PET containers, this can be done, for example, as with the introduction of scavengers or permeation inhibitors, e.g., using monolayer or multilayer technology. The pigments, laser additives, or similar substances may be distinguished by being wavelength-sensitive and/or thermosensitive. This means that they can react to certain wavelengths, energy doses, or exposure durations, etc., in a predictable way with a color change or shading effects (grayscale). A mixture of different materials with different sensitivities or sensitivity ranges can enable a wide spectrum of colors and effects. In principle, monochrome effects can also be sufficient. This can be the case, for example, when only an increase in contrast and thus an increase in the legibility of logos, fonts, or codes is necessary, which, for example, are formed into the surface of the container (e.g., in the stretch blow molding process or the like).

A special feature of the present disclosure is that a surface of the laser marking 36 of the containers 12 has at least one predetermined structuring 38 which is/was produced by the laser marking or by the laser marking system 10, as shown purely schematically in FIGS. 2 to 4.

By way of example, the surface of the laser marking 36 of the container 12 of FIG. 2 has three predetermined structurings 38. The surface of the laser marking 36 of the container 12 of FIG. 3 has two predetermined structurings 38. The surface of the laser marking 36 of the container 12 of FIG. 4 also has two predetermined structurings 38.

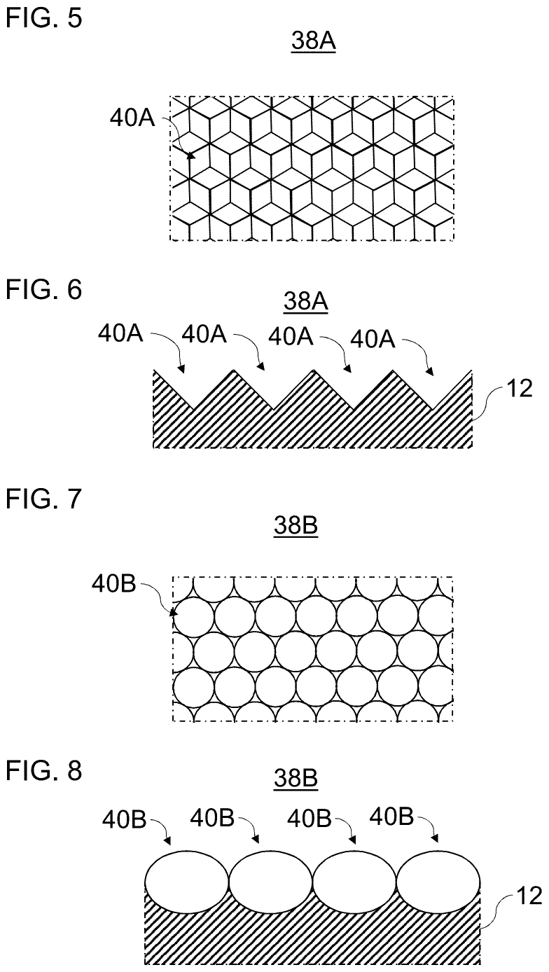

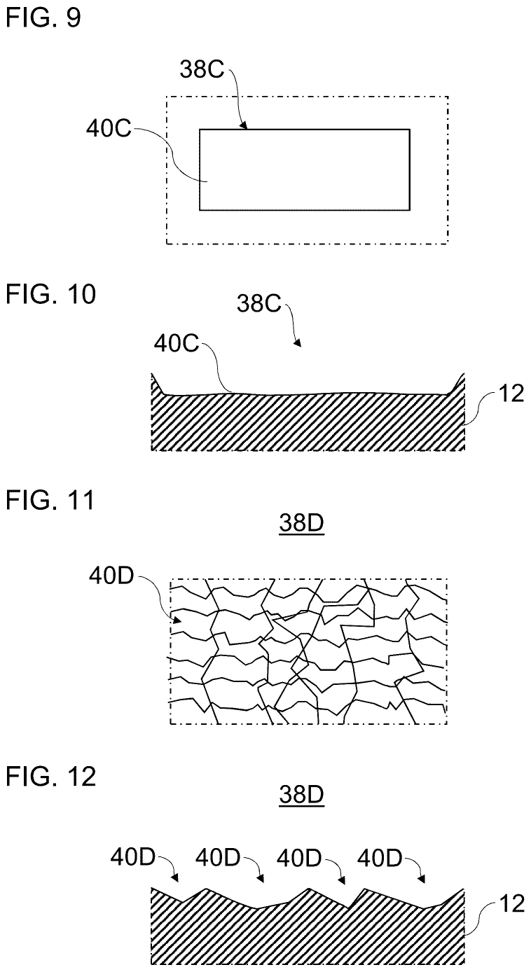

The structuring 38 is preferably a microstructuring, a nanostructuring, or a combined micro-nano-structuring. The structuring 38 can be a functional structuring to produce an optical effect. The at least one structuring 38 may preferably have a retroreflector structuring 38A, 38B, 38E, and/or 38F (see FIGS. 5 to 8 and FIGS. 13 to 16), a regular reflector structuring 38C (see FIGS. 9 and 10), and/or a diffuse reflector structuring 38D (see FIGS. 11 and 12).

If several predetermined structurings 38 are included, these may preferably differ structurally from one another. Preferably, different optical effects can be created via the structuring 38.

The several predetermined structurings 38 can directly adjoin each other and, for example, surround each other. However, it is also possible that the structurings 38 be arranged apart. Preferably, the structurings 38 do not overlap each other.

Each structuring 38 can have several structures 40.

The structures 40 of a respective structuring 38 can be arranged regularly or irregularly. The structures 40 of a respective structuring 38 can be arranged next to each other in a grid, a pattern, or a line. The structures 40 of a respective structuring 38 can be adjacent to each other. The structures 40 of a respective structuring 38 can be structurally the same or structurally different. The structures 40 of a respective structuring 38 can be microscale or nanoscale.

The several structures 40 can each be raised, preferably foamed, or recessed, preferably abraded, or a combination thereof.

Preferably, the several structures 40 can be raised differently relative to each other in different structurings 38, preferably foamed to a different degree, and/or recessed to a different degree, preferably abraded to a different degree.

In general, the structures 40 or the structurings 38 can be generated by an operation (parameter set) of the laser marking system 10 that is specific to the respective structuring 38. In this case, the laser marking system 10 can be operated by a controller depending upon the structuring 38 to be generated.

For example, a laser beam angle of incidence on the container 12, a combination of different laser beam angles of incidence on the container 12, a laser beam intensity or a combination of different laser beam intensities, and/or a laser beam wavelength or a combination of different laser beam wavelengths can be specifically prescribed for the respective structuring 38.

A laser beam pulse duration or a combination of different laser beam pulse durations, a spatial laser beam pulse spacing or a combination of different spatial laser beam pulse spacings, and/or a temporal laser beam pulse interval or a combination of different temporal laser beam pulse intervals can also be prescribed specifically for the respective structuring 38.

It is also possible to specify a focus diameter (focus spot) or a combination of different focus diameters (focus spots) specifically for the respective predetermined structuring 38.

FIGS. 5 to 8 show a retroreflector structuring 38A and a retroreflector structuring 38B.

The retroreflector structuring 38A, 38B can cause a so-called retroreflection of incident light. In retroreflection, light can be reflected largely independently of the direction or angle of incidence with respect to the orientation of the retroreflector structuring 38A, 38B, mostly in the direction of incidence, i.e., in the direction from which the light came.

As shown in FIGS. 5 and 6, the retroreflector structuring 38A can have several honeycomb or angle reflector structures 40A. Any honeycomb or angle reflector structure 40A can be configured for retroreflection.

The angle reflector structures 40A can preferably be arranged regularly, e.g., next to each other in a grid or pattern. The angle reflector structures 40A can, for example, be adjacent to each other or spaced apart from each other. The angle reflector structures 40A can preferably be structurally identical. The angle reflector structures 40A can preferably be microscale or nanoscale.

The angle reflector structures 40A can be formed as depressions in the surface, preferably produced by material removal caused by the laser marking system 10.

Each honeycomb or angled reflector structure 40A can have several reflector surfaces arranged at angles to each other. Particularly preferably, each honeycomb or angled reflector structure 40A has three reflector surfaces arranged at an angle to each other, which are arranged as a so-called triple mirror.

To generate the angle reflector structure 40A, laser beams or laser beam pulses with different angles of incidence can strike the surface of the container 12. For example, a different angle of incidence of the respective laser beam or laser beam pulse can be specified for each reflector surface of an angle reflector structure 40A and generated accordingly by the laser marking system 10. For example, for an angle reflector structure 40A with three reflector surfaces arranged at an angle to each other, which are arranged as a so-called triple mirror, three laser beams, three laser beam pulses, or three laser beam pulse bursts with different angles of incidence can be generated by the laser marking system 10 and hit the surface of the container 12 to create the angle reflector structure 40A.

As shown in FIGS. 7 and 8, the retroreflector structuring 38B can have several lens reflector structures 40B. Each 40B lens reflector structure can be configured for retroreflection.

The lens reflector structures 40B can preferably be arranged regularly, e.g., next to each other in a grid or pattern. The lens reflector structures 40B can, for example, be adjacent to each other or spaced apart from each other. The lens reflector structures 40B can preferably be structurally identical. The lens reflector structures 40B can preferably be microscale or nanoscale.

The lens reflector structures 40B can be formed as elevations in the surface, preferably generated by foaming the (e.g., plastic) material by the laser marking system 10.

Each lens reflector structure 40B can have an optical lens shape in cross-section. The lens shape can, for example, be ovoid or approximately spherical.

To generate the lens reflector structure 40B, laser beams or laser beam pulses with the same angle of incidence can strike the surface of the container 12, wherein a comparatively short irradiation time/pulse duration and/or a comparatively low laser beam intensity is selected.

FIGS. 9 and 10 show a regular reflector structuring 38C. The regular reflector structuring 38C can also be referred to as a direct reflector structuring.

The regular reflector structuring 38C can cause a so-called regular or direct reflection of incident light. In regular or direct reflection, incident light can be reflected at a certain angle, but not back in the direction from which the light came. Preferably, the angle of incidence and the angle of reflection to the incidence normal can thus be equal.

The regular reflector structuring 38C can have at least one planar surface structure 40C. The planar surface structure 40C can be substantially planar at the microscale or nanoscale.

The planar surface structure 40C can preferably be formed as an extensive depression in the surface, preferably generated by material removal caused by the laser marking system 10. The extensive depression may preferably have a substantially flat bottom on a micro-or nanoscale.

To generate the planar surface structure 40C, for example a laser beam from the laser marking system 10 can be guided continuously and line-by-line over the surface of the container 12. Preferably, adjacent lines can overlap. Alternatively, for example, a large number of laser pulses from the laser marking system 10 can hit the surface of the container 12 one after the other and side-by-side. Adjacent laser pulse impact points can preferably overlap.

FIGS. 11 and 12 Show a Diffuse Reflector Structuring 38D.

The diffuse reflector structuring 38D can cause a so-called diffuse reflection of incident light. In diffuse reflection, incident light can be reflected in a wide variety of directions-so-called scattered light.

The diffuse reflector structuring 38D can have several irregular structures 40D, resulting in an irregularly roughened surface at the microscale or nanoscale.

The irregular structures 40D can preferably be arranged irregularly next to each other. The irregular structures 40D can, for example, be adjacent to each other or spaced apart from each other. The irregular structures 40D are structurally different. The irregular structures 40D can preferably be microscale or nanoscale.

The irregular structures 40D can be formed as depressions in the surface, preferably generated by material removal caused by the laser marking system 10. Alternatively or additionally, the irregular structures 40D can be formed as elevations in the surface, preferably generated by foaming the (e.g., plastic) material by the laser marking system 10.

To generate the irregular structures 40D, laser beams or laser beam pulses can, for example, strike the surface of the container 12 with different angles of incidence, different intensities, different distances, and/or different pulse durations, etc.

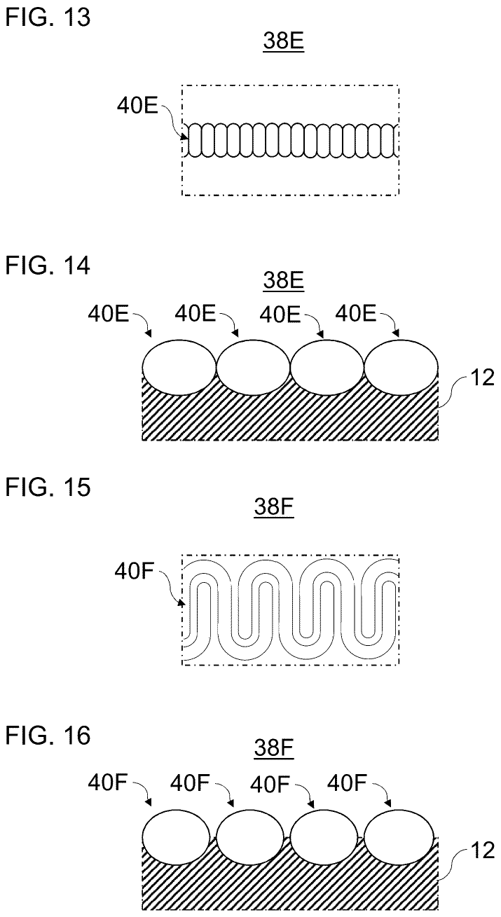

FIGS. 13 to 16 show a retroreflector structuring 38E and a retroreflector structuring 38F, which in turn can cause a so-called retroreflection of incident light.

The retroreflector structuring 38E, 38F can have several caterpillar-shaped lens reflector structures 40E or 40F. The caterpillar-shaped lens reflector structures 40E, 40F can, for example, be elongated or rod-shaped (see FIGS. 13 and 14) or curved, wavy, intertwined, and/or meandering (see FIGS. 15 and 16). Each lens reflector structure 40E, 40F can be configured for retroreflection.

The lens reflector structures 40E, 40F can preferably be arranged regularly, e.g., next to each other in a grid or pattern and/or intertwined. The lens reflector structures 40E, 40F can be arranged in a single row or in several rows, for example. The lens reflector structures 40E, 40F can, for example, be adjacent to each other or spaced apart from each other. The lens reflector structures 40E, 40F may preferably be structurally identical. The lens reflector structures 40E, 40F can preferably be microscale or nanoscale.

The lens reflector structures 40E, 40F can preferably be formed as elevations in the surface, preferably generated by foaming the (e.g., plastic) material by the laser marking system 10.

Each lens reflector structure 40E, 40F can have an optical lens shape in cross-section. The lens shape can, for example, be ovoid or approximately spherical.

To generate the lens reflector structures 40E, 40F, for example laser beams with the same angle of incidence can hit the surface of the container 12 and be moved across the surfaces along a desired path. Preferably, a comparatively short irradiation time/pulse duration and/or a comparatively low laser beam intensity can be selected.

The invention is not limited to the preferred exemplary embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the sub-claims are also disclosed independently of all the features of independent claim 1. All ranges specified herein are to be understood as disclosed in such a way that all values falling within the relevant range are individually disclosed, e.g., also as the relevant preferred, narrower, outer limits of the relevant range.

### LIST OF REFERENCE SIGNS

8 apparatus for marking containers
10 laser marking system
12 container
14 laser source
16 marking head
18 first mirror
20 first drive
22 second mirror
24 second drive
26 focusing device
30 container conveyor
32 container holder
34 inspection device
36 laser marking
38 predetermined structuring
38A retroreflector structuring
38B retroreflector structuring
38C regular reflector structuring
38D diffuse reflector structuring
38E retroreflector structuring
38F retroreflector structuring
40 structure
40A angle reflector structure
40B lens reflector structure
40C planar surface structure
40D irregular structure
40E lens reflector structure
40F lens reflector structure

1. A method for marking containers, wherein the method comprises:
laser marking a laser marking on a container using a laser marking system in such a way that a surface of the laser marking has at least one predetermined structuring, generated by the laser marking system.

2. The method according to claim 1, wherein:
the at least one predetermined structuring has several predetermined structurings that differ structurally from each other.

3. The method according to claim 2, wherein:
the several predetermined structurings directly adjoin one another, or
a first of the several predetermined structurings surrounds a second of the several predetermined structurings.

4. The method according to claim 1, wherein:
the at least one predetermined structuring has several structures, which are at least one of the following:
regularly arranged;
arranged side-by-side in a grid, pattern, or line;
adjacent to each other;
structurally the same; and
microscale or nanoscale.

5. The method according to claim 4, wherein:
the several structures have several honeycomb structures, several angle reflector structures, several lens reflector structures, several irregular structures, several caterpillar-like structures, several interlocking or meandering structures, and/or at least one planar surface structure that is substantially planar at the microscale or nanoscale; and/or
the several structures are each at least partially raised, and/or at least partially recessed.

6. The method according to claim 1, wherein:
the at least one predetermined structuring has a retroreflector structuring configured to cause retroreflection of incident light.

7. The method according to claim 6, wherein:
the retroreflector structuring has at least one of:
several honeycomb structures;
several angle reflector structures;
several lens reflector structures.

8. The method according to claim 1, wherein:
the at least one predetermined structuring has a regular reflector structuring configured to cause regular reflection of incident light.

9. The method according to claim 8, wherein:
the regular reflector structuring has at least one planar surface structure which is substantially planar on the microscale or nanoscale.

10. The method according to claim 1, wherein:
the at least one predetermined structuring has a diffuse reflector structuring configured to cause diffuse reflection of incident light, and, optionally,
the diffuse reflector structuring has several irregular structures that are distributed.

11. The method according to claim 1, wherein:
the at least one structuring is generated during laser marking by at least one of:
a laser beam angle of incidence, specifically prescribed for the respective predetermined structuring, on the container, or a combination of different laser beam angles of incidence, specifically prescribed for the respective predetermined structuring, on the container;
a laser beam intensity specifically prescribed for the respective predetermined structuring, or a combination of different laser beam intensities specifically prescribed for the respective predetermined structuring;
a laser beam wavelength specifically prescribed for the respective predetermined structuring or a combination of different laser beam wavelengths specifically prescribed for the respective predetermined structuring;
a laser beam pulse duration specifically prescribed for the respective predetermined structuring, or a combination of different laser beam pulse durations specifically prescribed for the respective predetermined structuring;
a spatial laser beam pulse interval specifically prescribed for the respective predetermined structuring, or a combination of different spatial laser beam pulse intervals specifically prescribed for the respective predetermined structuring;
a focus diameter specifically prescribed for the respective predetermined structuring, or a combination of different focus diameters specifically prescribed for the respective predetermined structuring; and
a temporal laser beam pulse interval specifically prescribed for the respective predetermined structuring, or a combination of different temporal laser beam pulse intervals specifically prescribed for the respective predetermined structuring.

12. The method according to claim 1, further involving:
producing or treating the container prior to laser marking in such a way that, at least in the region where the laser marking and/or the at least one predetermined structuring is laser marked, irreversibly thermochromic pigments or laser additives are introduced which react with a color change and/or a shading effect during laser marking.

13. The method according to claim 1, further involving:
detecting the laser marking and/or the at least one predetermined structuring after laser marking by an inspection device and
adapting the operation of the laser marking system and/or a container conveyor depending upon the detected laser marking and/or the detected at least one predetermined structuring by a controller.

14. A container, wherein the container has a laser marking produced by a method according to claim 1.

15. An apparatus for marking containers for a container processing facility, having:
a container conveyor for transporting the containers;
a laser marking system for laser marking the containers transported by the container conveyor; and
a controller configured to operate the apparatus to carry out a method according to claim 1.

16. The apparatus according to claim 15, wherein the container conveyor is configured for transporting the containers in an upright position.

17. The method according to claim 1, wherein the at least one predetermined structuring has several predetermined structurings that differ structurally from each other to produce different optical effects through the several predetermined structurings.

18. The method according to claim 2, wherein:
a first of the several predetermined structurings surrounds a second of the several predetermined structurings adjacently to the second predetermined structuring.

19. The method according to claim 6, wherein
each of the several angle reflector structures comprises three reflector faces arranged at an angle to each other, which are arranged as triple mirrors; and
the lens reflector structures have a circular, rod, or caterpillar shape.

20. The method according to claim 1, wherein at least one of the following conditions is met:
the at least one predetermined structuring has several predetermined structurings that differ structurally from each other to produce different optical effects through the several predetermined structurings;
the at least one predetermined structuring has several structures comprising several honeycomb structures, several angle reflector structures, several lens reflector structures, several irregular structures, several caterpillar-like structures, several interlocking or meandering structures, and/or at least one planar surface structure that is substantially planar at the microscale or nanoscale;
the at least one predetermined structuring has several structures that are each at least partially foamed, and/or at least partially abraded;
the at least one predetermined structuring has a diffuse reflector structuring configured to cause diffuse reflection of incident light, and the diffuse reflector structuring has several irregular structures that are distributed, resulting in an irregularly roughened microscale or nanoscale surface;
coating the container prior to laser marking in such a way that, at least in the region where the laser marking and/or the at least one predetermined structuring is laser marked, irreversibly thermochromic pigments or laser additives are introduced which react with a color change and/or a shading effect during laser marking; and
detecting the laser marking and/or the at least one predetermined structuring after laser marking by a camera-supported inspection device.
